(19) United States
(12) Patent Application Publication
(10) Pub. No.: US 2006/0124236 A1
(43) Pub. Date: Jun. 15, 2006

(54) Laminating apparatus and method and optical disk producer

(75) Inventor: Akira Mizuta, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/299,949

(22) Filed: Dec. 13, 2005

(30) Foreign Application Priority Data
Dec. 14, 2004 (JP) P.2004-361681

(51) Int. Cl. B32B 37/00

(52) U.S. Cl. 156/274.4; 156/379.6

(57) ABSTRACT

A laminating apparatus for laminating cover layers onto substrates respectively, comprising: support stages for supporting the substrates after the cover layers are laminated onto the support stages respectively; a grasping means capable of one by one conveying the substrates supported by the support stages while grasping the substrates; and static eliminating means for performing a static elimination process on each substrate in a condition that the substrate is separated from corresponding one of the support stages while grasped by the grasping means.

### FIELD OF THE INVENTION

The present invention relates to a laminating apparatus and method. Particularly, it relates to a laminating apparatus and method and an optical disk producer for laminating cover sheets onto disk substrates respectively.

### BACKGROUND OF THE INVENTION

Optical disks such as CD (compact disc), CD-R (compact disc-recordable), DVD (digital versatile disc), DVD-R (digital versatile disc-recordable), etc. have heretofore come into wide use.

In recent years, examination of high-density recording of information has advanced in accordance with the demand for storage of a larger quantity of information such as video information in an optical disk. The information recording density of the optical disk chiefly depends on the size of a light beam spot on the disk. The spot size is proportional to λ/NA in which λ is the wavelength of the laser beam, and NA is the numerical aperture of an objective lens. For this reason, increase in NA of the objective lens is effective while reduction in wavelength of the laser beam is required for increasing the recording density of the optical disk. Because coma aberration caused by inclination of the optical disk is in proportion to the cube of the NA, the margin for the inclination due to tilting, etc. of the disk however becomes very small with increase in the NA. Even when the disk is inclined slightly, the beam spot is blurred so that it is impossible to record and reproduce information with high density. Therefore, in a background-art optical disk suitable for higher density recording, a sufficiently thin (e.g. about 0.1 mm thick) cover layer is provided on a disk substrate so that the cover layer serves as a laser beam-transmissive layer in order to suppress increase of the coma aberration caused by inclination of the disk with increase in the NA.

In a line for production of the aforementioned optical disk, there is performed a process of half-punching cover layers of a thin film-like resin from a sheet into a predetermined shape in advance, separating the cover layers one by one and laminating the cover layers onto recording surfaces of disk substrates on which recording layers have been formed. Moreover, protective sheets are stuck onto front surfaces of the cover layers respectively in order to prevent the cover layers from being contaminated with dust or being damaged in the production line. In addition, there is performed a process of separating the protective sheets from the cover layers respectively after the cover layers are laminated onto the disk substrates.

FIG. 8A is a plan view showing part of an optical disk production line according to the background art. FIG. 8B is a side view showing the optical disk production line depicted in FIG. 8A.

As shown in FIGS. 8A and 8B, optical disks 101 having cover layers laminated onto disk substrates are placed successively on support stages 103 of a turntable 102 in the condition that the cover layers are turned upward. Then, the turntable 102 is rotated so that a protective sheet stuck onto the front surface of each cover layer is removed by a sheet removing portion 104. After removal of the protective sheet, the optical disk 101 is conveyed to an accumulation portion 107 while grasped by a rotary arm.

For example, ion radiation devices 105 are typically provided in order to eliminate static electricity from the front surfaces of the optical disks 101 disposed on the turntable 102 on this occasion. There is performed a process in which ions radiated from the ion radiation devices 105 are applied on the optical disks 101 disposed on the support stages 103 of the turntable 102 to thereby eliminate static electricity from the front surfaces of the optical disks (e.g. see Japanese Patent Laid-Open No. 2002-197737).

### SUMMARY OF THE INVENTION

When the ion radiation devices 105 apply ions on the optical disks 101 disposed on the support stages 103 of the turntable 102 as in the production line shown in FIGS. 8A and 8B, static electricity can be temporarily eliminated from the front surfaces of the optical disks but the optical disks 101 will be electrostatically charged again when the optical disks 101 are lifted up from the turntable 102 while grasped by the rotary arm 106. In this respect, there is still room for improvement.

The invention is achieved under such circumstances. An object of the invention is to provide a laminating apparatus and method for surely eliminating static electricity in a production line.

The foregoing object of the invention is achieved by a laminating apparatus for laminating thin film-like cover layers onto substrates respectively, including: support stages for supporting the substrates after the cover layers are laminated onto the support stages respectively; a grasping means capable of one by one conveying the substrates supported by the support stages while grasping the substrates; and static eliminating means for performing a static elimination process on each substrate in the condition that the substrate is separated from corresponding one of the support stages while grasped by the grasping means.

The foregoing object of the invention is achieved by a laminating method for laminating thin film-like cover layers to substrates respectively, including the steps of: supporting the substrates on support stages respectively after the cover layers are laminated onto the support stages; one by one conveying the substrates supported by the support stages while grasping the substrates by grasping means; and performing a static elimination process on each substrate in the condition that the substrate is separated from corresponding one of the support stages while grasped by the grasping means.

According to the invention, the static elimination process is performed on the substrate by the static eliminators in the condition that the substrate is once separated from corresponding one of the support stages while grasped by the grasping means such as a rotary arm. Accordingly, the whole of the substrate can be subjected to the static elimination process substantially at once. With this configuration, in the invention, it is possible to prevent static electricity from being generated in the substrate again due to migration of static electricity from the periphery of the substrate to the substrate after the static elimination process is performed only on the front surface of the substrate disposed on the support stage in the same manner as in the background art. Accordingly, in the process of laminating the thin film-like cover layer to the substrate, static electricity can be eliminated more surely from the cover layer and the substrate. The condition that the substrate is once separated from the support stage may be a condition that the substrate is grasped by the grasping means when the substrate is to be conveyed to another portion, or may be a condition that the substrate is separated while grasped for static elimination before conveyance of the substrate.

Preferably, the laminating apparatus further includes static eliminating means for performing a static elimination process on each substrate and each cover layer before the cover layer is laminated onto the substrate.

In the laminating apparatus, preferably, the static eliminating means are configured so that ions are blown onto opposite surfaces of each substrate by air. In addition, in the laminating method, preferably, the static elimination process is a process in which ions are blown by air. In this manner, ions can be blown onto the opposite surfaces of the substrate to thereby eliminate static electricity from the opposite surfaces entirely. Consequently, it is possible to eliminate electrical charge from the substrate more surely and more efficiently.

Preferably, there is provided an optical disk producer including the aforementioned laminating apparatus, wherein:

the substrates are disk substrates for optical disks having recording layers respectively; and the cover layers are laminated onto recording surfaces of the recording layers to thereby form light-transmissive protective layers respectively. In this manner, static electricity generated in the front surface of the optical disk can be eliminated surely while the recording layer can be laminated onto the disk substrate in the production line. Consequently, it is possible to improve efficiency in production of the optical disks.

According to the invention, it is possible to provide a laminating-apparatus and method and an optical disk producer for surely eliminating static electricity in a production line.

### BRIEF DESCRIPTION OF THE DRAWINGS

FIG. 1 is a view, partly in enlarged section, showing an optical disk produced by an optical disk producer.

FIG. 2 is a view showing the optical disk producer.

FIG. 3 is a side view showing part of the optical disk producer depicted in FIG. 2.

FIG. 4 is a view for explaining a process of producing a cover layer.

FIG. 5 is a view for explaining a state where a disk substrate is to be disposed on a support stage.

FIG. 6 is a view for explaining a state where a static elimination process is performed by static eliminators.

FIG. 7 is a view showing an example of the configuration of each static eliminator in the embodiment.

FIG. 8A is a plan view showing part of an optical disk production line according to the background art, and FIG. 8B is a side view showing the optical disk production line depicted in FIG. 8A.

### DESCRIPTION OF REFERENCE NUMERALS

1 optical disk
2 disk substrate
3 cover layer
4 recording layer
10 optical disk producer
23 rotary arm (grasping means)
27 support stage
50 static eliminator (static eliminating means)

### DETAILED DESCRIPTION OF THE INVENTION

An embodiment of the invention will be described below in detail with reference to the drawings. Although an optical disk producer is used as an example of a laminating apparatus and method in the description of this embodiment, the laminating apparatus and method is not limited to application to optical disks and can be used suitably for application to any product produced by lamination of a thin film-like sheet onto a substrate.

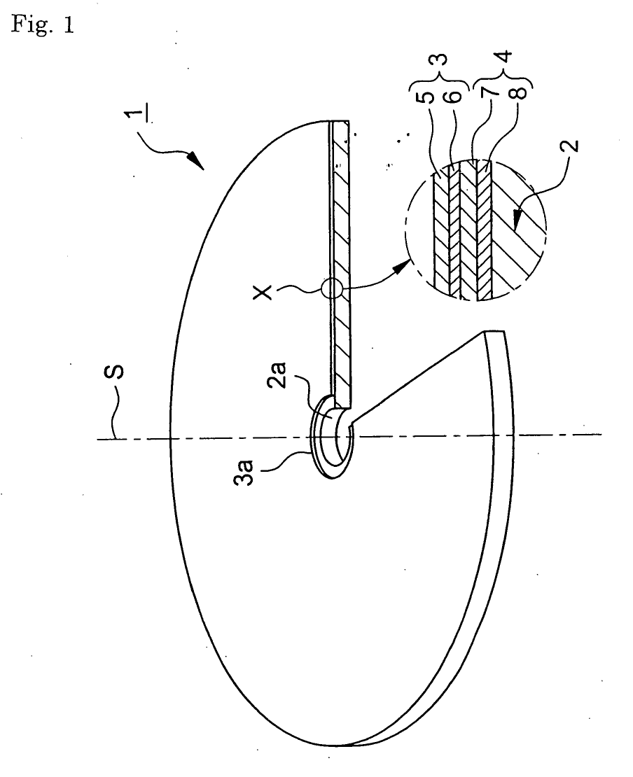

FIG. 1 is a view, partly in enlarged section, showing an optical disk produced by an optical disk producer according to this embodiment.

The optical disk 1 permits information recording with higher density than a background-art DVD. When, for example, the numerical aperture NA of an objective lens of a disk drive device is increased to about 0.85 while a blue-violet laser beam with a short wavelength is used as a recording/reproducing laser beam, the single-side recording capacity of the optical disk 1 with a diameter of 12 cm can be increased to about 27 GB compared with an optical disk according to the background art.

The optical disk 1 has a disk substrate 2 shaped like a discus. As shown in the enlarged section of a portion X in FIG. 1, an information recording layer 4 and a cover layer 3 are laminated successively on a single surface of the disk substrate 2 so that the recording layer 4 is covered with the cover layer 3.

The recording layer 4 is formed in such a manner that a light reflecting layer 8 and a light absorbing layer 7 are laminated successively on the disk substrate 2. The cover layer 3 has a tacky film 6 formed as its single surface, and a resin film 5 which serves as a transparent protective layer laminated on the recording layer 4 through the tacky film 6.

The disk substrate 2 is molded out of a resin such as polycarbonate. For example, the resin film 5 of the cover layer 3 is made of polycarbonate, TAC or PMMA (polymethyl methacrylate) whereas the tacky film 6 of the cover layer 3 is made of a tackifier (inclusive of a photo-setting resin adhesive agent) such as an acrylic tackifier, a rubber tackifier or a silicon tackifier. Especially, the acrylic tackifier is preferably used as the material of the tacky film 6 in terms of transparency and durability.

In this embodiment, the thickness of the cover layer 3, inclusive of the tacky film and the adhesive agent, in the optical disk 1 can be set to be in a range of from 95 μm to 105 μm. The thickness of the resin film 5 can be set to be in a range of from 10 μm to 100 μm. The thickness of the tacky film and the adhesive agent can be set to be in a range of from 5 μm to 30 μm.

A center hole 2a, which is shaped like a circle with a center axis S of rotation of the optical disk 1 as its center, is provided in the central portion of the disk substrate 2. A hole 3a, which is shaped like a circle with the axis S as its center and with a diameter larger than the diameter of the center hole 2a, is formed in the central portion of the cover layer 3.

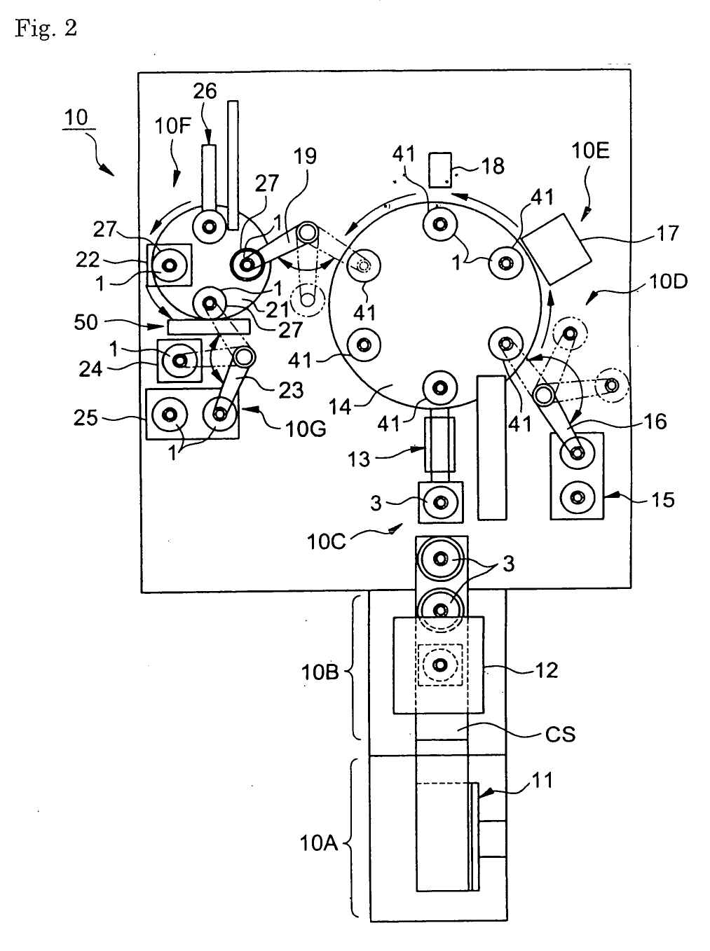

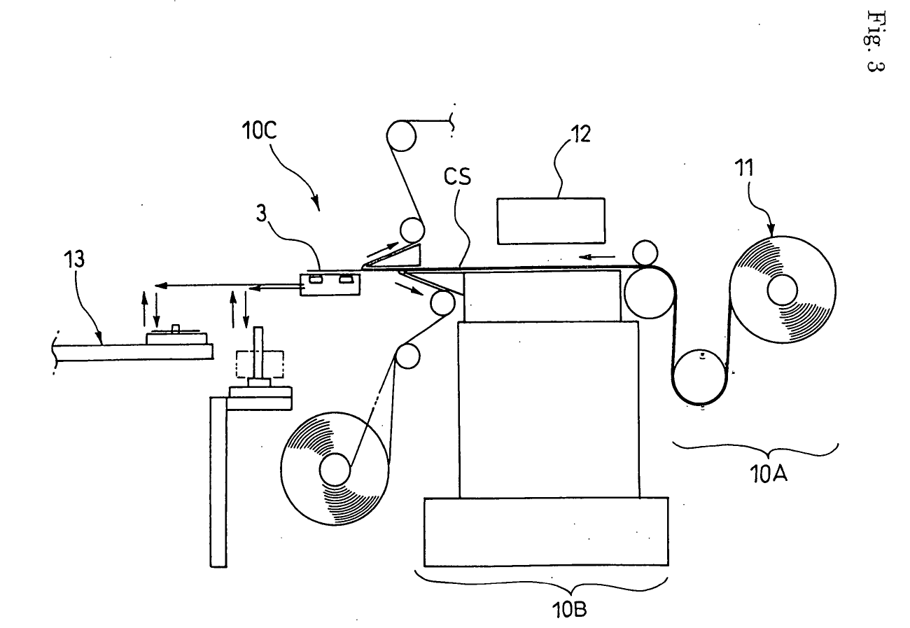

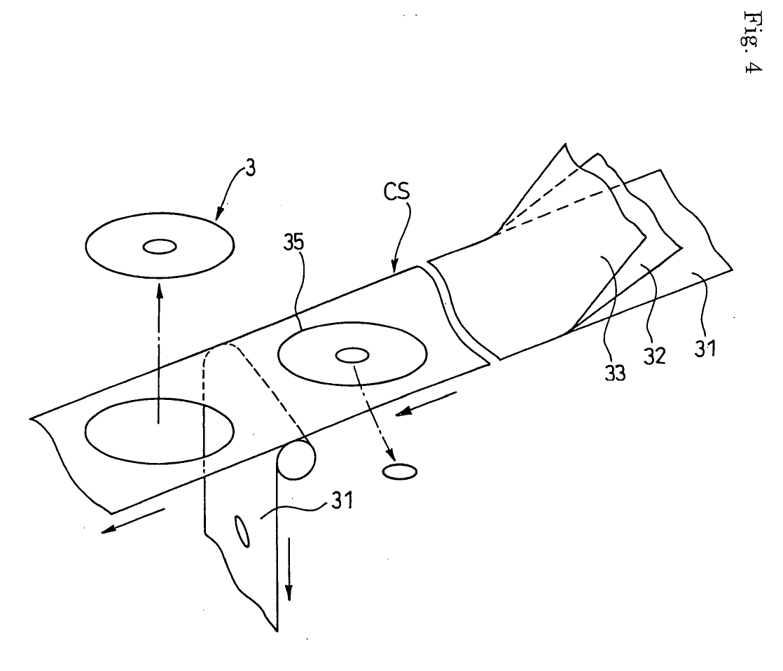

FIG. 2 is a view showing an optical disk producer. FIG. 3 is a side view showing part of the optical disk producer depicted in FIG. 2. FIG. 4 is a view for explaining a process of producing the cover layer.

The optical disk producer 10 includes a laminating apparatus for laminating a cover layer 3 onto each disk substrate 2 having a recording layer 4 laminated thereon in an optical disk production line.

In this embodiment, after a process of producing the disk substrate 2 and a process of producing the cover layer 3 are performed independently, a process of laminating the cover layer 3 onto the disk substrate 2 having the recording layer 4 laminated thereon is performed by the optical disk producer 10.

As shown in FIG. 4, each cover layer 3 is produced by processing a laminated sheet material (hereinafter referred to as “cover sheet CS”) which has a long belt-shaped resin film 32, a release sheet 31 stuck onto a tacky film formed on a single (lower side in FIG. 4) surface of the resin film 32, and a protective sheet 33 stuck onto the other surface of the resin film 32 opposite to the surface where the tacky film is formed.

The cover sheet CS is loaded into a sheet feeder portion 11 of a supply portion 10A in the condition that the cover sheet CS is rolled up. At the time of production, the cover sheet CS is fed out from the sheet feeder portion 11.

As shown in FIGS. 2 and 3, the cover sheet CS fed out from the sheet feeder portion 11 is conveyed to a punching portion 10B. The protective sheet 33 and the resin film 32 are punched out in the cover sheet CS by a ring-like punching die which is not shown but provided in a punching device 12. Thus, a circular punched portion 35 is formed. Incidentally, in the embodiment, the release sheet 31 of the cover sheet CS is not punched out at the time of punching, so that the release sheet 31 serves as a carrier for holding and conveying the punched portion 35 punched out in the cover sheet CS.

As shown in FIG. 3, after the cover sheet CS is punched in the punching portion 10B, the cover sheet CS is conveyed to a cover layer collection portion 10C. Circular cover layers 3 parted by the punched portions 35 are taken out successively. On the other hand, the release sheet 31, together with an unnecessary portion which is a portion except the punched portions 35 of the resin film 32, is collected. The cover layers 3 taken out by the cover layer collection portion 10C are conveyed by a transport portion 13.

The cover layers 3 are conveyed to a disc-like first turntable 14 via the transport portion 13 and disposed on support stages 41 provided at regular circumferential intervals on the first turntable 14. For example, the circumferential position of the first turntable 14 is changed by circumferential rotation control as represented by arrows in FIG. 2 to thereby change the respective positions of the support stages 41.

In the optical disk producer 10 according to this embodiment, a substrate supply portion 10D, a laminating portion 10E and a substrate inverter 18 are provided successively along the circumference of the first turntable 14 and in the direction of rotation of the first turntable 14.

The substrate supply portion 10D has a substrate feeder 15 for holding disk substrates 2 having recording layers 3 formed by another process. The substrate supply portion 10D is configured so that the disk substrates 2 held in the substrate feeder 15 are one by one grasped by a rotary arm 16, conveyed to the support stages 41 of the first turntable 14 and disposed on the support stages 41 respectively.

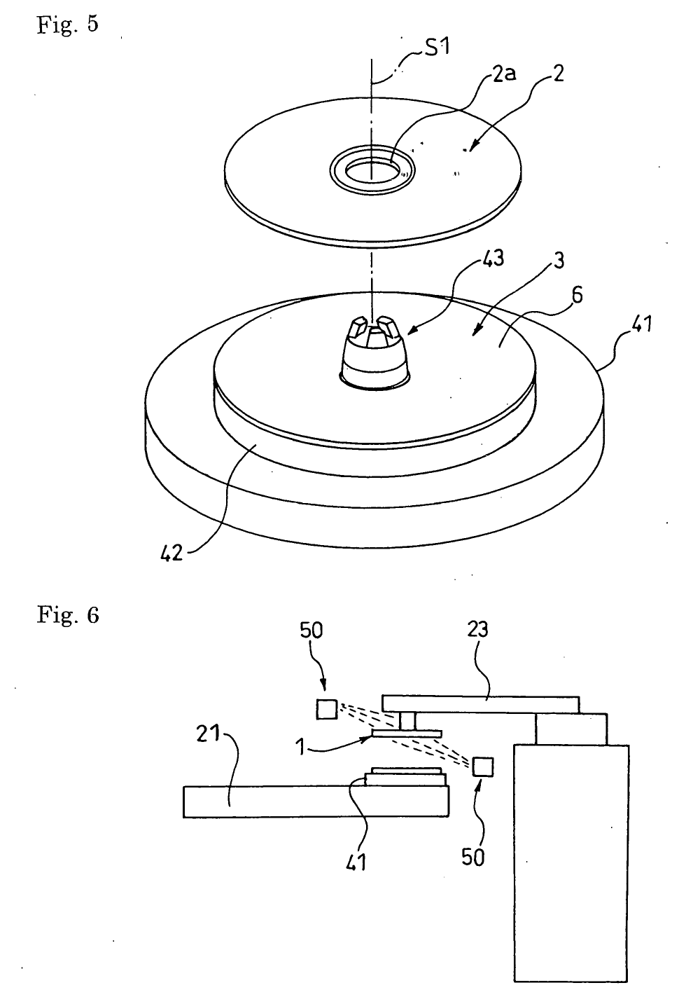

FIG. 5 is a view for explaining a state where a disk substrate is to be disposed on a support stage.

As shown in FIG. 5, a support portion 42 having a surface on which a cover layer 3 is disposed is formed on a support stage 41 of the first turntable 14. A center pin 43 kept protruded from the surface of the support portion 42 is provided in the support stage 41. When the center pin 43 is inserted in the hole 3a while the tacky film 6 is turned upward, the cover layer 3 is supported by the support portion 42 of the support stage 41 while positioned on the support portion 42. After the cover layer 3 is supported by the support stage 41, a disk substrate 2 is conveyed above the support portion 42 while grasped by the rotary arm 16. Then, in the condition that the recording layer 4 is turned downward, the center pin 43 is inserted in the center hole 2a of the disk substrate 2 so that the disk substrate 2 is temporarily held in an upper end portion of the center pin 43 while separated from the cover layer 3. On this occasion, the center axis S1 of the disk substrate 2 is made coincident with the center axis of the cover layer 3 supported by the support portion 42.

When the first turntable 14 is then rotated, the support stage 41 supporting the disk substrate 2 and the cover layer 3 is conveyed to the laminating portion 10E. In the laminating portion 10E, the center pin 43 is driven to move down from the support portion 42 in an airtight chamber (not shown) kept in a vacuum, so that the disk substrate 2 held at the upper end of the center pin 43 is laminated onto the cover layer 3 supported by the support portion 42, through the tacky film 6. In this manner, an optical disk 1 is roughly completed.

The optical disk 1 is conveyed to the substrate inverter 18 in accordance with the rotation of the first turntable and inverted by the substrate inverter 18, so that the cover layer 3 and the disk substrate 2 disposed on the support stage 41 are turned upside down. In this manner, the optical disk 1 is disposed in the condition that the cover layer 3 is exposed upward.

After inverted the substrate inverter 18, the optical disk 1 is moved with rotation of the first turntable 14, grasped by a rotary arm 19 and conveyed to a post-processing portion 10F. In the post-processing portion 10F, the optical disks 1 are disposed on support stages 27 provided at regular circumferential intervals on a second turntable 21 shaped like a discus. The second turntable 21 has basically the same mechanism as the first turntable 14. The second turntable 21 is configured so that the respective positions of the support stages 27 can be changed by circumferential rotation control of the second turntable 21 as represented by arrows in FIG. 2.

A protective sheet remover 26, a surface inspector 22 and static eliminators 50 are provided successively along the circumference of the second turntable 21 and in the direction of rotation of the second turntable 21.

The protective sheet remover 26 performs a process of removing the protective sheet 33 (see FIG. 4) stuck to the front surface of the cover layer 3 of each optical disk 1. After removal of the protective sheet 33, the optical disk 1 is conveyed to the surface inspector 22 in accordance with the rotation of the second turntable 21.

The surface inspector 22 inspects the front surfaces of the recording layer 4 and the cover layer 3 of the optical disk 1. In this manner, a defective optical disk 1 such as an optical disk having a cover layer 3 contaminated with dust or air bubbles can be detected.

A good optical disk 1 having no defect detected by the surface inspection is then conveyed to an accumulation portion 10G and collected in a finished product accumulation portion 25. On the other hand, an optical disk 1 having any defect detected by the surface inspection is conveyed from the second turntable 21 and collected in a defective product accumulation portion 24 while separated from the non-defective optical disk 1.

The static eliminators 50 are provided for eliminating static electricity from the electrostatically charged optical disk 1 after the optical disk 1 is inspected by the surface inspector 22 and before the optical disk 1 is conveyed to the accumulation portion 10G.

FIG. 6 is a view for explaining a state where a static elimination process is performed by the static eliminators.

After the optical disk 1 supported by each support stage 27 of the second turntable 21 is subjected to the process of removing the protective sheet 33 and to the surface inspection with the rotation of the second turntable 21, the optical disk 1 is moved to a position where the optical disk 1 can be grasped by a rotary arm 23 which serves as a grasping means for conveying the optical disk 1 to the accumulation portion 10G. The static eliminators 50 perform a static elimination process on the disk substrate 2 in the condition that the disk substrate 2 is separated from the support stage 27 while grasped by the rotary arm 23.

Incidentally, in this embodiment, as shown in FIG. 6, one of the pair of static eliminators 50 eliminates static electricity from the upper surface of the grasped disk substrate 2 while the other static eliminator 50 eliminates static electricity from the lower surface of the disk substrate 2. Alternatively, configuration may be made so that a single static eliminator 50 may perform a static elimination process on the opposite surfaces of the disk substrate 2.

Moreover, the rotary arm 23 may be configured so that the optical disk 1 supported by the support stage 27 of the second turntable 21 is separated from the support stage 26 while grasped by the rotary arm 23 only for the purpose of eliminating static electricity before the optical disk 1 is conveyed to the accumulation portion 10G side.

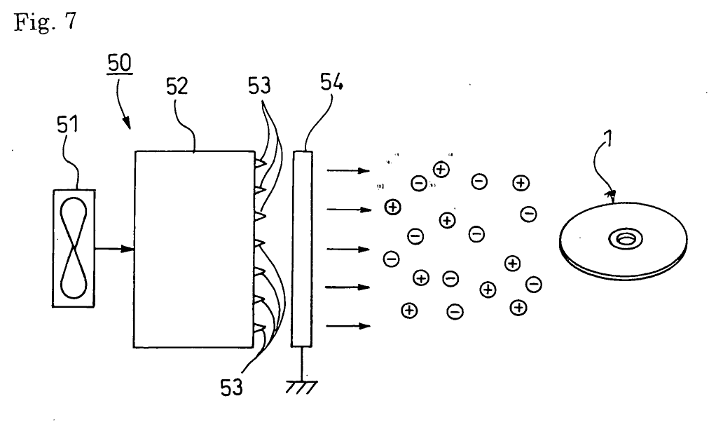

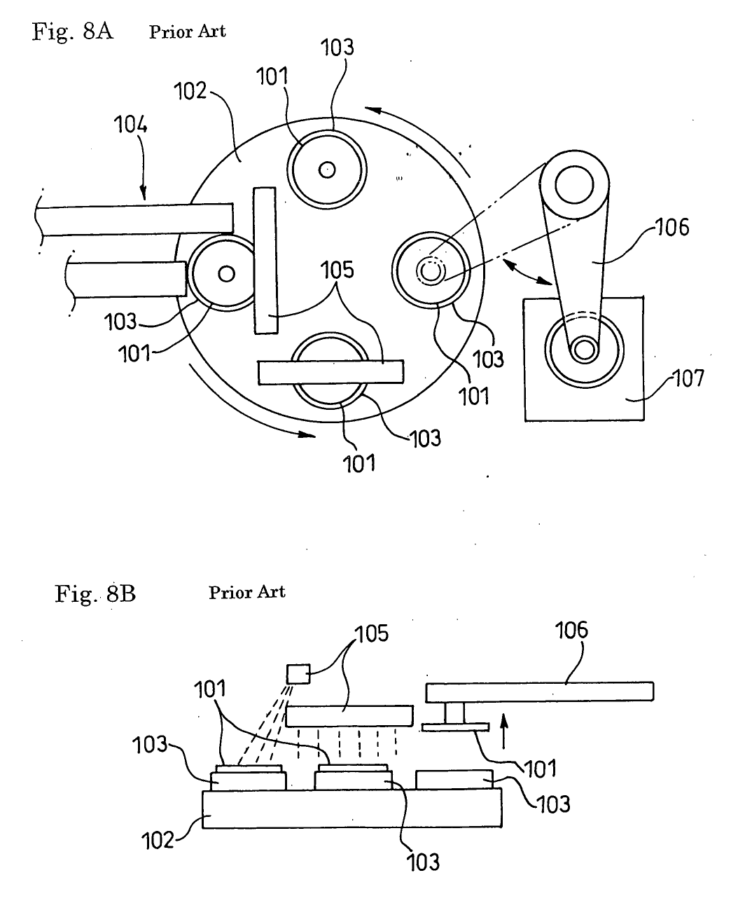

FIG. 7 is a view showing an example of the configuration of each static eliminator in the embodiment.

The static eliminator 50 has a fan 51, a discharge device 52, and a rod-like or plate-like ground electrode 54 which is grounded.

Discharge electrodes 53 shaped like a large number of needles are disposed in the discharge device 52. For driving the static eliminator, a high voltage source provided in the inside or outside of the discharge device 52 applies a high AC or DC voltage to the discharge electrodes 53. When a high voltage is applied, plus and minus ions are generated due to electric discharge between the discharge electrodes 53 and the ground electrode 54. These ions are flown together with air sent from the fan 51, so that the ions are blown onto a surface of the optical disk 1.

Although the embodiment has shown the configuration of the static eliminator in which the ions are blown onto the disk substrate 2 without contact between the static eliminator and the disk substrate 2, another configuration may be used. Examples of a non-contact static eliminator having the other configuration include a high-frequency corona discharge type (AC or DC) static eliminator, a wire type static eliminator, and a weak X-ray radiation type static eliminator not requiring air blowing. Examples of a contact static eliminator having the other configuration include a static eliminator having a static eliminating brush.

According to this embodiment, the static elimination process is performed on the opposite surfaces of the disk substrate 2 by the static eliminators 50 in the condition that the disk substrate 2 is separated from the support stage 27 while grasped by the rotary arm 23. With this configuration, it is possible to prevent static electricity from being generated in the disk substrate again due to migration of static electricity from the periphery of the disk substrate to the disk substrate after the static elimination process is performed only on the front surface of the disk substrate disposed on the support stage in the same manner as in the background art. Accordingly, in the process of laminating the thin film-like cover layer 3 onto the disk substrate 2, it is possible to surely eliminate static electricity generated in the cover layer 3 and the disk substrate 2.

In addition, when the static eliminators 50 are configured so that ions are blown by air, the ions can be blown onto the opposite surfaces of the disk substrate 2 so that static electricity can be eliminated from the opposite surfaces entirely. Accordingly, it is possible to eliminate electric charge from the disk substrate 2 more surely and more efficiently without static electricity remaining in any other portion of the disk substrate 2. The quantity of electrification of the front surface of the disk substrate 2 is generally selected to be preferably not higher than 1 kV, further preferably not higher than several hundreds V.

Static eliminating means for performing a process of eliminating static electricity from the disk substrate and the cover layer respectively may be preferably provided before the cover layer is laminated onto the disk substrate. In such a manner, it is possible to eliminate electrical charge from the front surface of the disk substrate more surely and it is also possible to eliminate electrical charge from the cover layer. On this occasion, the static eliminators according to the embodiment can be used as the static eliminating means.

Incidentally, the invention is not limited to the embodiment. Suitable changes and modifications may be made on the embodiment.

For example, in the configuration in which the cover layer is laminated onto the disk substrate in the optical disk producer as described in the embodiment, static electricity can be surely eliminated from the cover layer and from the disk substrate respectively before the cover layer is laminated onto the disk substrate. In addition, the invention can be applied to a laminating apparatus provided with a process of laminating thin film-like cover layers to substrates of a resin or the like for the purpose of producing other products than the optical disks.

Although the above description has been made on the case where the optical disk producer 10 is configured so that the static eliminators 50 perform a static elimination process after the surface inspector 22 performs surface inspection, the surface inspector may be provided between the static eliminators 50 and the accumulation portion 10G so that the surface inspection can be performed after the static elimination process.

This application is based on Japanese Patent application JP 2004-361681, filed Dec. 14, 2004, the entire content of which is hereby incorporated by reference, the same as if set forth at length.

What is claimed is:

1. A laminating apparatus for laminating cover layers onto substrates respectively, comprising:
support stages for supporting the substrates after the cover layers are laminated onto the support stages respectively;
a grasping means capable of one by one conveying the substrates supported by the support stages while grasping the substrates; and
static eliminating means for performing a static elimination process on each substrate in a condition that the substrate is separated from corresponding one of the support stages while grasped by the grasping means.

2. The laminating apparatus according to claim 1, wherein the static eliminating means are configured so that ions are blown onto opposite surfaces of each substrate by air without contact between the static eliminating means and the substrate.

3. A laminating method for laminating cover layers to substrates respectively, comprising:
supporting the substrates on support stages respectively after the cover layers are laminated onto the support stages;
one by one conveying the substrates supported by the support stages while grasping the substrates by grasping means; and
performing a static elimination process on each substrate in a condition that the substrate is separated from corresponding one of the support stages while grasped by the grasping means.

4. The laminating method according to claim 3, wherein the static elimination process is a process for blowing ions onto opposite surfaces of each substrate by air.

5. An optical disk producer including the laminating apparatus as defined in claim 1, wherein:
the substrates are disk substrates for optical disks having recording layers respectively; and
the cover layers are laminated onto recording surfaces of the recording layers to thereby form light-transmissive protective layers respectively.

6. The laminating apparatus according to claim 1, further comprising static eliminating means for performing a static elimination process on each substrate and each cover layer before the cover layer is laminated onto the substrate.
